(19) United States
(12) Patent Application Publication
(10) Pub. No.: US 2025/0148307 A1
(43) Pub. Date: May 8, 2025

(54) PREDICTIVE MACHINE LEARNING SYSTEM FOR EARLY IDENTIFICATION AND RECOMMENDATION OF STRATEGIC INTERVENTIONS TO IMPROVE PARTICIPANT OUTCOMES

(71) Applicant: Devin Canaday, Chester, VA (US)

(72) Inventor: Devin Canaday, Chester, VA (US)

(21) Appl. No.: 18/503,510

(22) Filed: Nov. 7, 2023

(51) Int. Cl. G06N 5/022

(52) U.S. Cl. CPC G06N 5/022

(57) ABSTRACT

A system and method are presented in this invention for a machine learning model configured to generate recommendations to improve the probability of a desired outcome for participants in a program. Individual profile data for past and current participants, which includes participant attributes derived internal and external to the program, are used to conduct a series of assessments of the participant population to determine the probability of participants to achieve the desired outcome(s). Inputs to the assessments include the output(s) of the previous assessment(s) conducted in the series. Past participants with the undesired and desired results are assessed to identify detrimental and beneficial impactors to teach the system about the specific participant population(s) based on the plurality of attributes within the participant profiles. Individually tailored recommendations are automatically generated for current participants as a function of the identified impactors and tracked to further refine future recommendations generated by the system.

### FIELD OF INVENTION

The present invention related to artificial intelligence and machine learning and more specifically related to early identification and recommendations to improve participant outcomes.

### BACKGROUND

The following description includes information that may be useful in understanding the present invention. It is not an admission that any of the information provided herein is prior art or relevant to the presently claimed invention, or that any publication specifically or implicitly referenced is prior art.

The goal of every school division across our nation is to prepare our next generation for post-secondary success. This requires students to matriculate through the primary and secondary grade levels to graduation with an educational foundation sufficient for them to move forward into the job force, military, or post-secondary educational pursuits, regardless of what that may be. Despite the efforts of school divisions, it is inevitable that there will be students who will not make it through to graduation, opting to dropout for any multitude of reasons. Students who drop out of school directly affect the graduation rate(s) of the school division, which serves as a key performance indicator for the division and often directly impacts the level of funding allocated by the local, county, state, or federal governing agency.

In order to address this problem most school divisions have created a heightened focus on three (3) major strands: academic performance, behavioral record and attendance engagement. By monitoring and tracking these strands, denoted as KPIs, schools believe they can respond with the appropriate supports to improve student performance and success. However, each of these KPIs is the result of underlying issues, rendering the solution(s) implemented as reactive rather than proactive. The intervention based on academics is after the student has already performed poorly. An intervention for behavior is implemented after the student has exhibited undesired behaviors. And similarly, interventions based on student attendance is after the student has already missed instructional time. The reality is these 3 KPIs are merely indicators of a potential plurality of underlying issues leading to low or declining academic performance, increased behavior incidents and poor attendance habits. By failing to properly identify the root cause(s) the intervention initiatives rolled out by the school will have little impact to change the situation due to the originating issue not being addressed.

The outlined invention directly addresses this issue by identifying the plurality of factors that, when present, serve as early indicators of a student's increased probability of not making it to graduation. While these factors include the three formerly mentioned KPIs, it goes further to include other academic, enrollment, community and demographic data points. A process for screening these factors based on the unique make-up of the local student population(s) and generating data-driven, informed interventions does not currently exist for schools to implement. While the proposed invention finds its genesis in promoting student graduation, the model can be applied to any program with participants who matriculate through with the potential to achieve desired and undesired outcomes.

### BRIEF SUMMARY OF THE INVENTION

The nature and purpose of the invention presented is to define a predictive logic model for an early warning, early intervention system to increase the probability of achieving desired outcomes for participants within a given program. As presented, the predictive model is built upon a machine learning process that conducts assessments of program participants to identify the attributes that contribute to the program outcomes that are unique to the population of program participants. Past participants with the undesired and desired results are assessed to identify detrimental and beneficial impactors to teach the system about the specific participant population(s) based on the plurality of attributes within the participant profiles.

Once identified, these impactors are overlaid atop the current program participants to create sub-groups of participants with presenting attributes that are noted to impact program outcomes. Based on the individual attributes facing a participant, tailored recommendations are automatically generated by the predictive system for current participants. These recommendations include resources that are available both internal to and external to the program and deemed effective for promoting desired program outcomes for participants. As each intervention is implemented, the participant's progress is monitored and tracked to determine the effectiveness of the specific implementation for the unique participant. The collective monitoring of all participants allows the predictive system to further refine future recommendations generated by the system.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 shows a top-level overview of the core components that comprise the predictive model, in accordance with one of the embodiments of the present invention.

FIG. 2 depicts the system level flow diagram for the predictive model, in accordance with one of the embodiments of the present invention.

FIG. 3 illustrates the details of assessment 1, in accordance with one of the embodiments of the present invention, which reviews the process for identifying critical attributes, defined as impactors, which are commonly present in participant populations who have matriculated towards the undesired program outcome(s).

FIG. 4 illustrates the process for assessment 2, in accordance with one of the embodiments of the present invention, which assesses the subgroups formed by assessment 1 to identify beneficial attributes, defined as assets, which are commonly present in the participant populations that have matriculated towards the desired program outcomes and the potential effectivity of each identified asset.

FIG. 5 illustrates the process for assessment 3, which combines the outputs of both assessment 1 and assessment 2, in accordance with one or more embodiments of the present invention to generate individualized intervention recommendations for program participants that increase the probability of achieving the desired program outcome(s).

### DETAILED DESCRIPTION AND BEST MODE OF IMPLEMENTATION

The various embodiments of the invention are described more fully hereinafter in reference to the accompanying drawings. The embodiments represented in the included figures are comprehensive but not exhaustive. Indeed, these figures, as represented, are intended to provide sufficient illustration to communicate the nature and method of the invention to address the defined problem described in the background section of this report. This invention may be embodied in many different forms and should not be construed as limited to the exact embodiments set forth herein; rather, these embodiments are provided in this disclosure to satisfy applicable legal requirements.

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

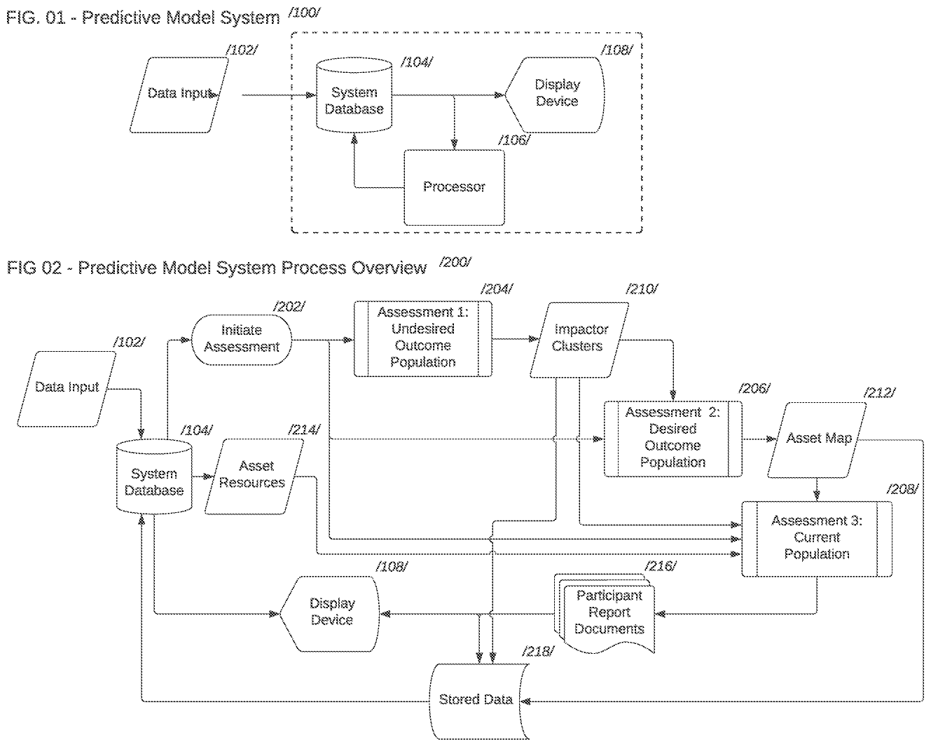

FIG. 1 illustrates the system level embodiment (100) of the invention. The three (3) core components of the assembly include the System Database (104), the Processor (106), and a Display Device (108). The System Database (104) serves as the core repository for storing personnel profile data. The Database (104) receives raw profile data from any number of input sources, referred to as Data Input (102) in FIG. 1.

The system further comprises a monitoring system to monitor the personal progress and corresponding intervention implementation for one or more participants before displaying such information to the user.

This input may be via an automated electronic push, a manual electronic upload, or other manual input processes. All data entered into the System Database (104) is stored for future retrieval and processing. Data that is processed via the various assessments, hereinafter described, is stored in the Database (104) to update profile data for program participants, as well as allowing for the monitoring and tracking of participant performance in response to the interventions implemented in accordance with the recommendations generated by the system, as described hereafter.

The processor (106) of FIG. 1 represents the system component responsible for the assessment and manipulation of personnel profile data to learn the unique factors present in the participant population impacting the program outcomes for the participants. The processor (106) performs the plurality of assessment activities, defined in the subsequent sections of this disclosure. As a part of the assessment process, the processor (106) overlays resource data, sourced from the system database (104), generates the recommendations for program interventions tailored to each program participant that is identified by the prior assessments, and supports report preparation and monitoring for program management oversight. The results of each assessment, the intervention plans and reports, and the participant progress can be retrieved from the database (104) and displayed in the Display Device (108). This display device is typically a digital monitor, however, may be any variety of output medium and user interface.

FIG. 2 presents the embodiments of the Predictive Model System (200) that assess the personnel data of past and current participants in a given program. The represented diagram shows how data is pulled from the database for the various assessments, following the flow of outputs from each assessment to support the subsequent assessments leading to the creation of the intervention recommendations to help improve participant outcomes. The block diagram illustrates the order of operations in the logic model, identifying the inputs needed for each assessment, and the outputs from each assessment activity. The Initiate Assessment (202) step requires personnel profile data from the System Database (104) stored as a result of the Data Input (102).

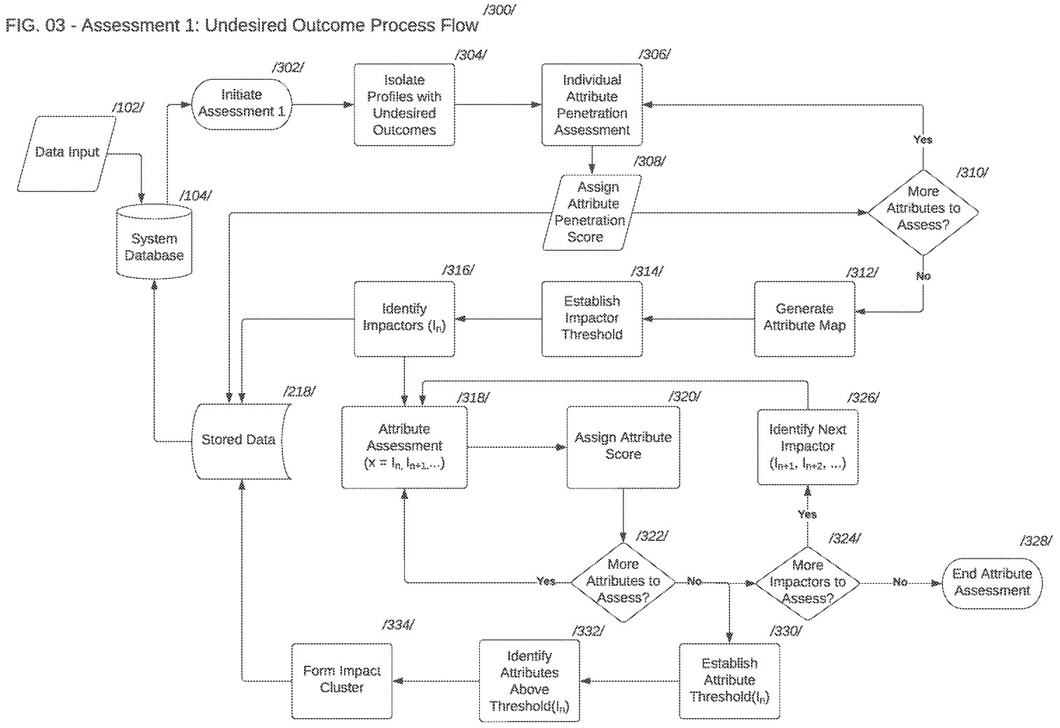

The first assessment to be conducted is the Undesired Outcome Population Assessment (204). This assessment generates the baseline for understanding the participant population to teach the machine learning model. The assessment (204), illustrated in FIG. 03 and described hereinafter, conducts a series of comparative assessments of the target participant group to create Impact Clusters (210). These Impact Clusters (210) are specific combinations of personnel attributes that individually may have little impact on the program outcome for any participant, yet, when in concert together have been evidenced to increase the probability of undesired outcomes for the participant population. To use an example from the originating background of the invention, consider students within an educational system working towards graduation. The assessment (204) will appraise students who dropped out of school, failing to graduate, to identify the combination of attributes present in the population of dropped out students. Consider a student from an economically disadvantaged family, who has experienced housing instability and multiple school transitions. This student may have also had low academic performance and inconsistent school attendance. Review of these presenting attributes individually may not exceed a dropout probability greater than 20%. Yet, the assessment of these attributes together, in alignment with the total population of students who have dropped out, may yield a dropout probability of over 83%. This highlights the Impact Cluster (210) as a discriminator in the early identification process as it accounts for the plurality of attributes present for the student.

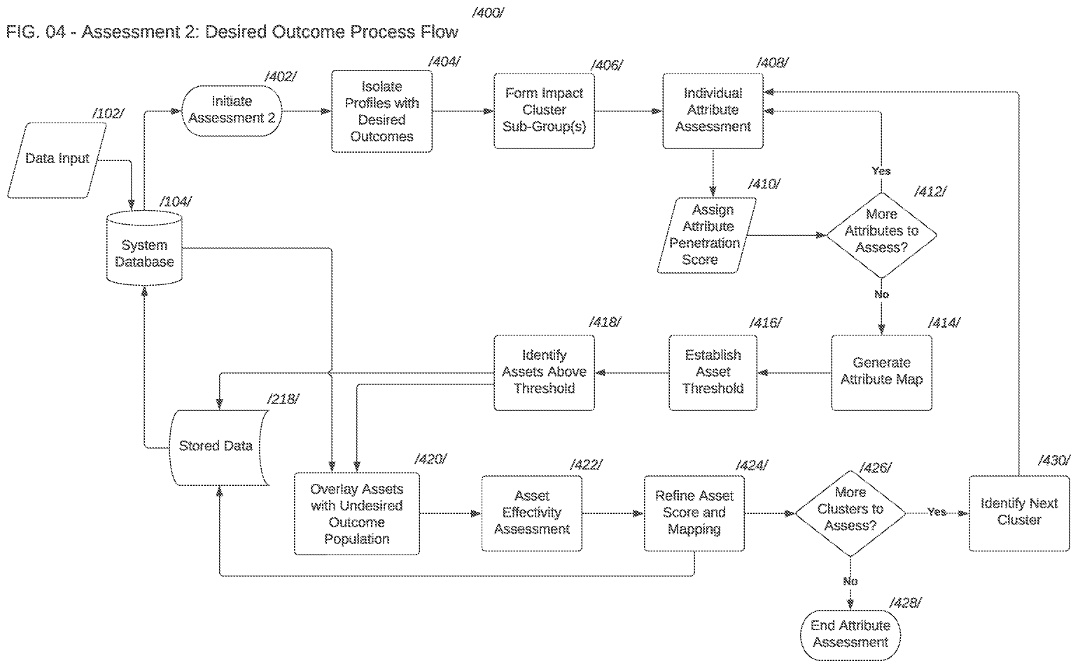

Following the generation of the Impact Clusters (210) of the Undesired Outcome Population Assessment (204), the Desired Outcome Population Assessment (206) is conducted. The assessment (206), illustrated in FIG. 04 and described hereinafter, conducts a series of comparative assessments of the target participant group. This process creates the second layer of machine learning for the prediction model to teach the system about the participant population. The required input for the Assessment (206) is the Impact Clusters (210) and the personnel data for program participants who achieved the desired program outcome(s). The Assessment (206) groups students with attributes matching the impact clusters to assess what attributes are present in the participant data contributing to the achievement of the desired outcome(s). These identified attributes form the Asset Map (212), which identifies the attributes shown to counteract the detrimental effects of the attributes that comprise the impact cluster. Continuing with the student-based example, such assets may be the students' participation in tutoring programming and the acquisition of a part-time job. The presence of these two attributes could reduce the dropout probability of the student described in the previous section down from 83% to 34%.

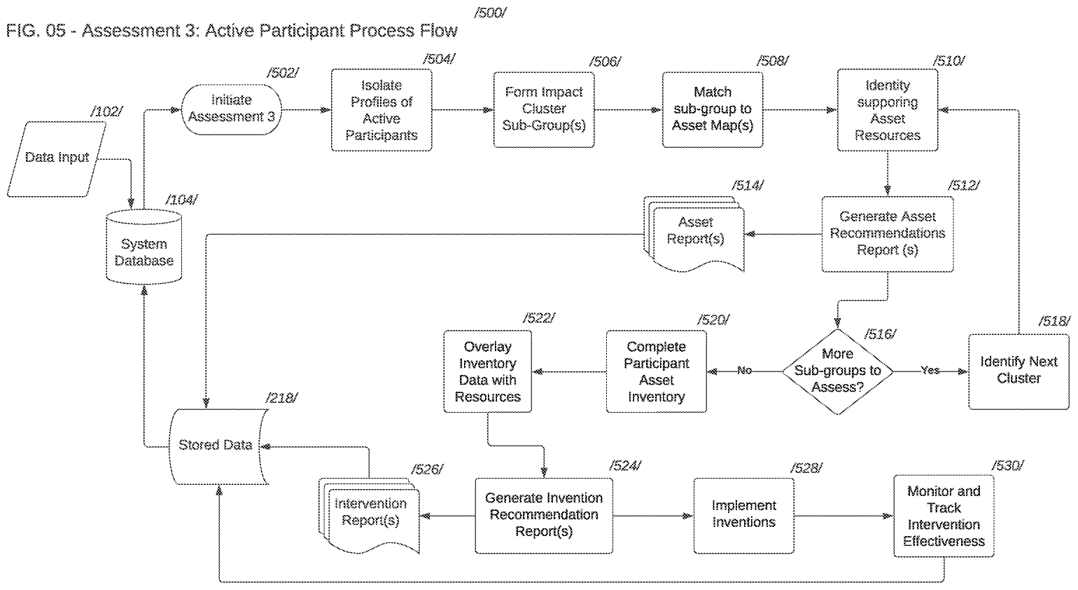

The appraisal of the current participant population is conducted within the Current Population Assessment (208) step. The Assessment (208) illustrated in FIG. 05 and described hereinafter, conducts a series of comparative assessments of the current participant group. The Impact Clusters (210) and Asset Map (212) are the required inputs for this step, as well as the current inventory of Asset Resources (214) to yield the Participant Report Documents (216). Using these inputs, the current participant population will be grouped by Impact Clusters (210), then aligned to the Asset Map (212) of attributes evidenced to increase the probability of the desired program outcome(s). Lastly, in this assessment (208) step, the current inventory of resources is reviewed to identify the specific resources needed by each participant. The interventions recommended, as well as the projected effectiveness of each intervention, is captured in the Report (216) that is generated by the Assessment (208). The output of each assessment: the Impact Clusters (210), the Asset Map (212), and the Participant Report Documents (216), are stored in the System Database (104). At any time, data stored in the Database (104) can be retrieved for review or monitoring via a Display Device (108).

FIG. 3 illustrates the details of assessment 1, wherein the method is based on the Undesired Outcome Population Assessment (204) of FIG. 02. This assessment creates the foundation for the machine learning model of the predictive system through analyzing the attributes common to past program participants that achieved results which did not meet the established measure of success for the program. The process initiates with the Isolation of Profiles with Undesired Outcomes (304).

All personnel data stored in the System Database (104) associated with participants who achieved undesired program outcomes is queried in order to build a comprehensive list of attributes. The plurality of attributes is run through an Individual Attribute Penetration Assessment (306). Thus assessment assigns an Attribute Penetration Score (308) which directly correlates to the percentage of the participant population who exhibits that specific attribute. The algorithm repeats this penetration assessment until all attributes have been scored. The score of each attribute is stored in the database (218). Au Attribute Map (312) is generated once all attributes have been assessed. This map (312) charts the participant attributes along a curve based on the returned penetration scores. The next process of the logic algorithm is to Establish the Impactor Threshold (314). This Threshold (314) sets a minimum penetration score that is statistically derived through assessing the percentage of the population represented by each attribute. The intent of the Threshold (314) is to maximize the total participant population represented by the least number of attributes Once established, the attributes with scores greater than the Threshold (314) are reclassified as Impactors (316) and stored in the database (218). An Impactor (316) is defined as an individual attribute found to have a detrimental influence on an individual participant as a result of the penetration assessment. This detrimental influence increases the probability of the participant to achieve an undesired outcome for the program, as evidenced by the penetration scores.

The Attribute Assessment (318) is conducted on all attributes, similar to the Penetration Assessment (306), only this time as a function of each impactor (x=I₁, I₂, . . . Iₙ). In this assessment (316) the impactor Iₙ, where “I” is the specific impactor and “n” is the total number of impactors, is held as a constant and each attribute is assessed for penetration and scored (320). All attributes, including those classified as an impactor, which are not Iₙ, are scored (322). Once all attributes have been assessed and scored as a function of I₁, the assessment is run again for I₂, and so on through Iₙ (324). Following the completion of each Impactor assessment, a new Attribute Threshold is established (330). Attributes with penetration scores exceeding the threshold are identified (332) and grouped together with the Impactor to form an Impact Cluster (334). An Impact Cluster (334) is a grouping of attributes found to work in concert with one another to increase a program participant's probability to achieve undesired outcomes. This probability imposed on the participant from the cluster is greater than that imposed by any single attribute working in isolation. These Impact Clusters (334) are stored (218) in the System Database (104) for future retrieval.

FIG. 04 illustrates the process for assessment 2, wherein the method is based on the Desired Outcome Population Assessment (206) of FIG. 02. This assessment builds upon the machine learning model of the predictive system through analyzing the attributes common to past program participants that achieved results which met or exceeded the established measure of success for the program. The process initiates with the Isolation of Profiles with Desired Outcomes (404). All personnel data stored in the System Database (104) associated with participants who achieved desired program outcomes is queried in order to build a comprehensive list of attributes associated with each participant. The Impact Clusters (210) formed in the previous Undesired Outcome Population Assessment (204) are used to create participant Sub-Groups (406). The participants in the sub-groups either completely match the exact attribute make-up of a particular Impact Cluster (210) or closely match it. As an example, consider a student matriculating toward graduation. This student may have a matching set of attributes of an Impact Cluster (210) with the exception of the Grade Point Average cutoff. Thus student would still be part of a sub-group associated with the impact cluster. Including this student provides a data point for the algorithm to help teach the system during the Individual Attribute Assessment (408), which follows the formation of the Impact Cluster Sub-Group(s) (406).

The plurality of attributes is run through an Individual Attribute Assessment (408). This assessment assigns an Attribute Penetration Score (410) which directly correlates to the percentage of the participant population who exhibits that specific attribute. The score of each attribute is stored in the database (218) and the algorithm repeats this penetration assessment until all attributes have been scored (412). An Attribute Map (414) is generated once all attributes have been assessed. This map (414) charts the participant attributes along a curve based on the returned penetration scores. The next process of the logic algorithm is to Establish the Asset Threshold (416). This Threshold (416) sets a minimum penetration score that is statistically derived through assessing the percentage of the population represented by each attribute. The intent of the Threshold (416) is to maximize the total participant population represented by the least number of attributes. Once established, the attributes with scores greater than the Threshold (416) are reclassified as Assets (418) and stored in the database (218). An Asset (418) is defined as au individual attribute found to have a beneficial influence on an individual participant, counteracting the detrimental effects of the attributes of the Impact Cluster (210)). This beneficial influence increases the probability of the participant to achieve a desired outcome for the program, as evidenced by the penetration scores.

To determine the effectivity of the Assets (418), each asset is overlaid with the Undesired Outcome Population (420). The scores returned by this overlay (420) are paired with the penetration scores of the Attribute Assessment (408) within the Asset Effectivity Assessment (422) step. This Assessment (422) improves the systems understanding of each asset and the impact each has on the participant population to promote matriculation towards the desired outcome(s) of the program. The Asset Score and Attribute Mapping (424) is updated, aligned to the Impact Cluster (210), then stored (218) in the System Database (104). This process is repeated for each Cluster sub-group until all have been assessed and assigned an asset map.

FIG. 5 illustrates the culmination of the multi-part assessment process for the predictive model. The process is a combination of outputs of both assessment 1 and assessment 2. The figure illustrates the method of the Current Population Assessment (208) of FIG. 02, yielding individualized recommendations for program participants. The Assessment (208) initiates by Isolating the Current Participants (504) and forming attribute-based Sub-Groups (506) as a function of the Impact Clusters (210). Each sub-group is then matched to the associated Asset Map (212) for the Impact Cluster (210). The System Database (104) is then queried to generate a list of Asset Resources (510) available for program participants. An Asset Resource (214) is a discrete internal or external service that directly aligns with an attribute on the Asset Map (212). As an example, if a student has poor academic performance as an impactor and tutoring has been identified as an asset, the specific asset resource may be a community partner who offers math tutoring for students.

The predictive model transitions to the intervention phase of the process hereafter. The specific Resources (214) aligning to the attributes of the Asset Map (212) are used to generate Asset Recommendation Reports (512). Each program participant represented in the sub-group will have an individual Asset Report (514) created and stored (218) in the System Database. The resource mapping is conducted for each sub-group (516) until all sub-groups have been mapped. Further fine-tuning of the Reports (216) is accomplished by having each program participant complete an Asset Inventory (520). The Inventory (520) takes into account the personal interest and motivations of the individual participant. The data gathered through this survey is entered in the database to be overlaid with the Resources (522) on the Report (216). An Intervention Recommendation Report (524) is generated from the down-selected list of Resources (214) to create increased alignment of interventions with participant interest and motivations. The reports are stored (218) in the System Database (104) for each participant. Program leadership then oversees the implementation of the recommended interventions (528), monitoring and tracking the effectiveness of the interventions (530) through the system. The system continues the machine learning process by flowing the intervention effectiveness associated with each resource deployed to support a program participant back into the system to generate a resource score. This information is used for future intervention recommendations to improve the mapping of Resources (214) to program participants with specific Impact Clusters (210).

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

As used herein, the term engine refers to software, firmware, hardware, or other component that can be used to effectuate a purpose. The engine will typically include software instructions that are stored in non-volatile memory (also referred to as secondary memory). When the software instructions are executed, at least a subset of the software instructions can be loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

As used herein, the term database is used broadly to include any known or convenient means for storing data, whether centralized or distributed, relational or otherwise.

As used herein a mobile device includes, but is not limited to, a cell phone, such as Apple's iPhone®, other portable electronic devices, such as Apple's iPod Touches®, Apple's iPads®, and mobile devices based on Google's Android R operating system, and any other portable electronic device that includes software, firmware, hardware, or a combination thereof that is capable of at least receiving the signal, decoding if needed, exchanging information with a transaction server to verify the buyer and/or seller's account information, conducting the transaction, and generating a receipt. Typical components of mobile device may include but are not limited to persistent memories like flash ROM, random access memory like SRAM, a camera, a battery, LCD driver, a display, a cellular antenna, a speaker, a Bluetooth® circuit, and WIFI circuitry, where the persistent memory may contain programs, applications, and/or an operating system for the mobile device.

The embodiments of the invention in which an exclusive property or privilege is claimed are defined as follows:

1. A system (100) comprising:
a processor (106) for executing a series of assessment, scoring and grouping activities for individual attributes and generating intervention recommendations;
a database (104) for storing raw and processed personnel data wherein the database receives personnel data via manual input mediums and automated importing from electronic systems of record,
a monitoring system configured to monitor personnel progress and corresponding intervention implementation; and
a display device (108) to display the results.

2. The system of claim 1, wherein comprehensive personnel data is received and stored in the database includes a plurality of individual attributes used to build personnel profiles for program participants

3. The system of claim 1, wherein individual participants coded as having achieved undesired program outcomes are isolated for the stage 1 predictive assessments; the method used serves as the initial population assessment to form the foundational parameters for consideration in the predictive model

4. The method of claim 3, wherein an individual attribute is assessed to determine the level of penetration in the isolated population of participants; the assessment returns a score as a result of the penetration assessment, recorded and stored in the database for attribute ranking; the penetration assessment is completed for each participant attribute to build a comprehensive attribute map for the affected participant population.

5. The method of claim 3, wherein attributes are ranked in accordance with the level of assessed penetration in the affected participant population.

6. The method of claim 5, wherein attributes are statistically mapped by an algorithm; the algorithm generates a statistical threshold that maximizes the number of participants represented; attributes with penetration scores above the threshold are classified as impactors; an impactor is an individual attribute found to have a detrimental influence on an individual participant as a result of the penetration assessment.

7. The system of claim 1, wherein the attribute rankings, threshold value(s), and identification of impactors generated in claim 6 are stored in the database: stored data is made available to retrieve and review through the monitoring system.

8. The method of claim 6, wherein the participant attributes are iteratively re-assessed as a function of each impactor; attributes of the re-assessment include attributes classified as impactors; attributes within the sub-population of participants represented by the impactor are scored and ranked as a result of the penetration re-assessment.

9. The method of claim 8, wherein the algorithm generates a statistical threshold for the sub-population that maximizes the number of participants represented; attributes with penetration scores above the threshold are grouped with the impactor to form an impact cluster; an impact cluster is a plurality of impactors found to work in concert together and have a detrimental influence on an individual participant leading to undesired program outcomes, as a result of the penetration re-assessment.

10. The system of claim 1, wherein the impact clusters generated in claim 9 are stored in the database, stored data is made available to retrieve and review through the monitoring system.

11. The method of claim 9, wherein the impact clusters represent the primary output of the first stage of the predictive model used to generate prediction probabilities for the active participant population to achieve the desired outcome(s) in alignment to past participant outcomes as determined by the assessment of the sub-population of participants represented by the undesired program outcome(s).

12. The system of claim 1, wherein participants coded as having achieved the desired program outcome(s) are isolated for the predictive asset mapping assessment; impact clusters of claim 9, stored in the database, are used to serve as the variable for the assessment of the target population of program participants.

13. The method of claim 12, wherein participants coded with the desired program outcome(s) are isolated for comparative assessment as a function of impact clusters; sub-groups of the population are formed in alignment with each impact cluster.

14. The method of claim 13, wherein the sub-group is iteratively assessed to determine the level of penetration of each attribute not identified by the impact cluster into the isolated population of participants: the assessment returns a score for each attribute as a result of the penetration assessment; the scores are recorded and stored in the database.

15. The method of claim 14, wherein attributes are ranked in accordance with the level of assessed penetration in the affected participant population.

16. The method of claim 15, wherein attributes are statistically mapped by an algorithm; the algorithm generates a statistical threshold for attribute representation in the participant population; attributes with penetration scores above the threshold are classified as assets; an asset is an individual attribute found to have a beneficial influence on an individual participant and counteracts the detrimental effects of the impactor(s).

17. The method of claim 16, wherein the population of participants with the undesired outcomes matching the specific impact cluster are assessed to determine asset penetration in the sub-group; the assessment returns an effectivity rating for each asset; the effectivity rating is merged with the score of claim 14 to refine the asset score.

18. The system of claim 1, wherein the asset mapping generated in claim 16 is stored in the database, stored data is made available to retrieve and review through the monitoring system, asset maps form the first layer of the machine learning model; the machine learning model represents the second stage of the predictive model of claim 11, to be utilized to generate intervention strategies for active participant populations to improve the probability of participants achieving the desired program outcome(s), in alignment to past participant decisions as determined by the assessment of the participant population having had already achieved the desired program outcome(s).

19. The system of claim 1, wherein resources are identified, entered into and stored in the database of assets as possible intervention solutions that directly relate to, impact, or counteract impactors of the participant population, as determined by claim 16; asset resources represent a plurality of interventions, services and strategies to improve participant outcomes.

20. The system of claim 19, wherein the asset resources are stored in the database form the second layer of the machine learning model of claim 18; the asset resource listing serves to increase the breadth of capacity for recommendation generation for participant interventions; each resource is mapped in association with category(s) represented by the asset map.

21. The system of claim 1, wherein participants coded as active, or having not yet achieved a program outcome, whether desired or un-desired, are isolated for predictive assessment; the method used serves as the initial population assessment to form the foundation of the intervention model; the intervention model represents the third stage of the prediction model of claim 11 for the overall prescribed system.

22. The method of claim 21, wherein active participants are categorized into sub-groups in accordance with the matching impact cluster(s) with the associated projection of probability for participants to matriculate towards the undesired program outcome(s).

23. The method of claim 22, wherein participant sub-groups are matched to the supporting asset map of claim 16, in association with the specific impact cluster of claim 9.

24. The method of claim 23, wherein the participant sub-groups are matched to available asset resources of claim 19, in association with the sub-group's assigned asset map.

25. The method of claim 24, wherein the asset recommendations are summarized and assigned to the participant profile stored in the database.

26. The method of claim 24, wherein each participant identified with increased probability of undesired outcomes in accordance with the representation of the impact cluster within their respective participant profile is to complete an asset inventory.

27. The method of claim 26, wherein data collected from each participant as a result of the asset inventory is stored in the database: stored data forms the third layer of the machine learning model of claim 18, winch is unique to each participant; the inventory data serves to expand the breadth of capacity for recommendation generation for participant interventions and improve the effectiveness of recommended interventions.

28. The method of claim 27, wherein the predictive model generates individualized intervention plans for each identified participant of the affected population; the intervention plan summarizes areas of need, the specific asset resources to consider for the participant, and the projected rate of impact each recommended intervention may have on the participant, as generated by the machine learning model assessment of the three (3) layers of asset data.

29. The system of claim 1, wherein intervention plans are stored in the database, with the implementation of each recommended intervention tracked; the effectiveness of each intervention is monitored.

30. The system of claim 1, wherein new profile data is routinely uploaded to the system; participant profiles are reviewed for elimination of impactors following the initial participant assessment; participant profile changes are recorded with each additional data upload.

31. The system of claim 30, wherein profile changes identified with each data upload improves the fidelity of the machine learning model and effectiveness rating for each associated asset resource.

32. The method of claim 31, wherein the predictive model refines the intervention plan for each participant profile; recommendations for new resources are identified and provided to promote participant progress towards the desired program outcome(s).
